(19) United States
(12) Patent Application Publication
(10) Pub. No.: US 2011/0052891 A1
(43) Pub. Date: Mar. 3, 2011

(54) GAS BARRIER FILM AND METHOD OF PRODUCING THE SAME

(75) Inventors: Toshiya TAKAHASHI, Shizuoka (JP); Satoshi AIBA, Kanagawa (JP)

(73) Assignee: FUJIFILM CORPORATION, Tokyo (JP)

(21) Appl. No.: 12/868,148

(22) Filed: Aug. 25, 2010

(30) Foreign Application Priority Data
Aug. 26, 2009 (JP) 2009-195671

(51) Int. Cl. B32B 7/02; B05D 1/36; B32B 9/00

(52) U.S. Cl. 428/213; 427/294; 428/688; 428/698; 428/702; 428/446

(57) ABSTRACT

A gas barrier film comprises: a flexible film; a first organic layer formed at atmospheric pressure on a surface of the flexible film; a second organic layer formed in vacuum on a surface of the first organic layer; and an inorganic layer formed in vacuum on a surface of the second organic layer.

### BACKGROUND OF THE INVENTION

The present invention relates to a gas barrier film for use in displays. The present invention more specifically relates to a gas barrier film having organic layers and one or more inorganic layers stacked on a surface of a flexible film and capable of being produced with high efficiency and a method of producing the gas barrier film.

A gas barrier film which has a layer exhibiting gas barrier properties on a surface of a plastic film such as polyethylene terephthalate (PET) film is used not only in such positions or parts that require moisture resistance in various devices including optical devices, displays such as liquid-crystal displays and organic EL displays, semiconductor devices, and thin-film solar cells, but also in packaging materials used to package food, clothing, electronic components, and the like.

A layer made of any of various inorganic materials (inorganic compounds) such as silicon nitride, silicon oxide and aluminum oxide is known as the layer exhibiting gas barrier properties that may be used in such a gas barrier film.

Also known is a laminate type gas barrier film (gas barrier laminate film) that has a plurality of layers including organic layers (organic compound layers) and an inorganic layer (inorganic compound layer) stacked on a surface of a flexible film to achieve still higher gas barrier properties.

For example, JP 2003-341003 A describes a gas barrier film comprising a first resin thin film layer having a mean surface roughness of 4 nm or less and made of an epoxy compound which is formed on a surface of a flexible film; a vapor deposition layer of an inorganic oxide formed by vapor-phase deposition on the first resin thin film layer; and a second resin thin film layer of the same type as the first resin thin film layer formed on the vapor deposition layer.

U.S. Pat. No. 6,420,003 describes a gas barrier film comprising a first crosslinked acrylate layer formed on a surface of a thermoplastic flexible film; an oxygen barrier layer of an inorganic material such as silicon oxide or aluminum oxide formed on the first crosslinked acrylate layer; and a second crosslinked acrylate layer of the same type as the first crosslinked acrylate layer formed on the oxygen barrier layer.

These gas barrier films can have excellent gas barrier properties by forming an organic layer on a surface of a flexible film to cover fine topographic features at the surface of the flexible film to thereby give a highly smooth surface and forming an inorganic layer (gas barrier film) made of an inorganic oxide on the highly smooth surface.

The inorganic layer mainly exhibiting gas barrier properties is protected by forming another organic layer on the inorganic layer. In addition, a plurality of layers including organic layers and inorganic layers can be stacked on top of each other to achieve still higher gas barrier properties while releasing the stress of the inorganic layer and ensuring the flexibility of the gas barrier film.

The inorganic layer is generally formed by vapor-phase deposition techniques (vacuum deposition techniques) such as plasma-enhanced CVD, sputtering and vacuum evaporation.

On the other hand, flash evaporation is advantageously used to form the organic layer as described in JP 2003-341003 A and U.S. Pat. No. 6,420,003.

As described above, the organic layer is formed to ensure the smoothness of the surface on which the inorganic layer is to be formed, and the organic layer obtained has a very high surface smoothness by using flash evaporation.

What is more, flash evaporation is a technique in which film deposition is performed in vacuum, and therefore formation of the first organic layer by flash evaporation, formation of the inorganic layer by vapor-phase deposition and formation of the second organic layer by flash evaporation can be continuously performed in a single vacuum chamber, thus also preventing dust or foreign matter from adhering to the film deposition surface.

For example, JP 2003-341003 A and U.S. Pat. No. 6,420,003 each describe a device in which a drum is disposed in a vacuum chamber and the first organic layer, the inorganic layer and the second organic layer are sequentially formed by a first flash evaporation unit, a CVD unit (vacuum evaporation unit) and a second flash evaporation unit each disposed so as to face a peripheral surface of the drum as the flexible film travels on the drum in a longitudinal direction.

In such a gas barrier film having organic layers and inorganic layers stacked on top of each other, the organic layers formed have a larger thickness than the inorganic layers.

In other words, the surface topographic features of the flexible film can be covered to obtain a sufficiently smooth surface by forming the organic layer having a certain degree of thickness.

For example, according to JP 2003-341003 A, the organic layer thickness is preferably from 5 to 2000 nm and the inorganic layer thickness is preferably from 5 to 500 nm.

In addition, JP 2003-341003 A describes in Examples a gas barrier film comprising a flexible film (PET film); a first organic layer (transparent epoxy layer) with a thickness of 500 nm formed on the flexible film; and an inorganic layer (silicon oxide layer) with a thickness of 100 nm formed on the first organic layer, and another gas barrier film further comprising a second organic layer of the same type as the first organic layer formed on the inorganic layer of the above-described gas barrier film.

The difference between the thickness of the organic layer and that of the inorganic layer may hinder the improvement of the productivity. For example in cases where the inorganic layer has a thickness of 50 nm, the film deposition rate is 500 nm/min and the organic layer has a thickness of 500 nm, the organic layer must be formed at a film deposition rate of 5000 nm/min so that the organic layer may be formed in time before the formation of the inorganic layer is started.

Therefore, as described in JP 2003-341003 A and U.S. Pat. No. 6,420,003, in cases where a gas barrier film is produced by continuously performing the formation of the first organic layer by flash evaporation, the formation of the inorganic layer by vapor-phase deposition and optionally the formation of the second organic layer as a long flexible film travels in a longitudinal direction, the travel speed of the flexible film is determined by the organic layer-forming step and the flexible film cannot travel at a higher speed.

In other words, in a conventional gas barrier film production method which uses flash evaporation and with which an organic layer and an inorganic layer are stacked on top of each other, the inorganic layer is formed on a highly smooth film deposition surface to enable a gas barrier film having excellent gas barrier properties to be produced, but the formation of the organic layer becomes a rate-determining factor to hinder high productivity or high-speed production.

### SUMMARY OF THE INVENTION

In order to solve the aforementioned prior art problems, an object of the present invention is to provide a gas barrier film exhibiting excellent gas barrier properties and capable of high-speed production.

Another object of the present invention is to provide a gas barrier film production method capable of producing such a gas barrier film.

A gas barrier film according to the present invention comprises: a flexible film; a first organic layer formed at atmospheric pressure on a surface of the flexible film; a second organic layer formed in vacuum on a surface of the first organic layer; and an inorganic layer formed in vacuum on a surface of the second organic layer.

A method of producing a gas barrier film according to the present invention comprises the steps of: making a flexible film in strip form travel in a longitudinal direction thereof; forming a first organic layer at atmospheric pressure on a surface of the flexible film which is traveling; forming a second organic layer in vacuum on a surface of the first organic layer; and forming an inorganic layer in vacuum on a surface of the second organic layer.

### BRIEF DESCRIPTION OF THE DRAWINGS

FIG. 1A schematically shows the layout of an organic deposition device used to produce a gas barrier film according to an embodiment of the present invention;

FIG. 1B schematically shows the layout of a vacuum deposition device used to produce the gas barrier film according to this embodiment;

FIG. 2 is a partial cross-sectional view showing a gas barrier film according to this embodiment;

FIG. 3A is a partial cross-sectional view showing a gas barrier film in a modified embodiment; and

FIG. 3B is a partial cross-sectional view showing a gas barrier film in another modified embodiment.

### DETAILED DESCRIPTION OF THE INVENTION

On the following pages, the gas barrier film and the method of producing the gas barrier film according to the present invention are described in detail with reference to the preferred embodiments shown in the accompanying drawings.

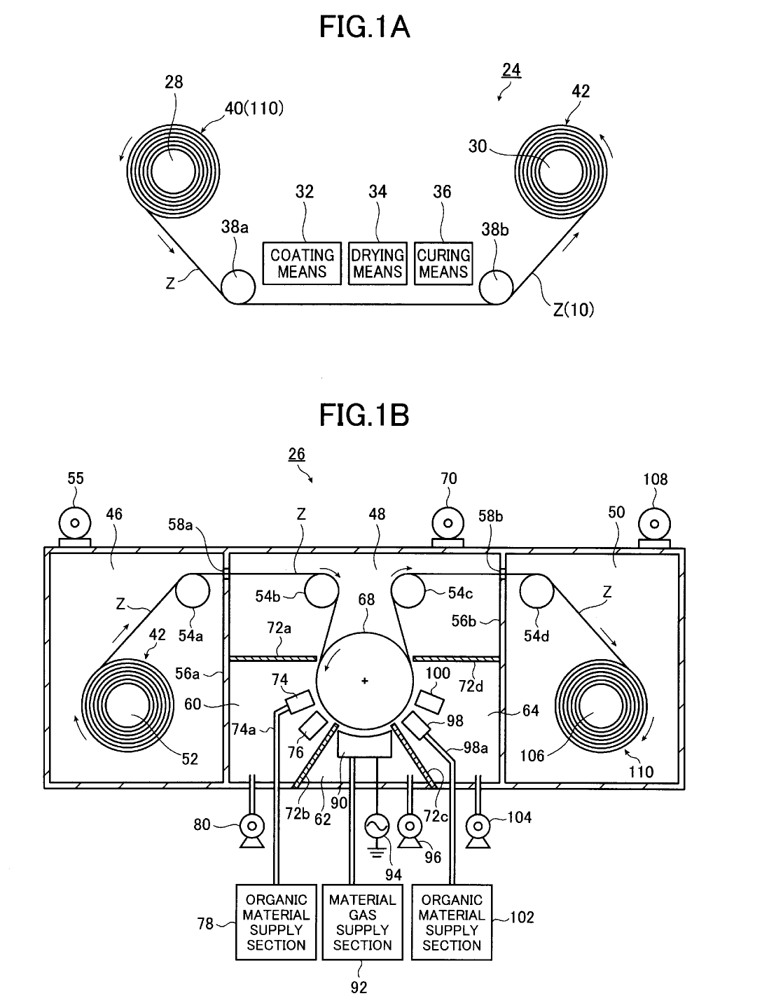

FIGS. 1A and 1B show schematic layouts of an organic deposition device 24 and a vacuum deposition device 26 used to produce a gas barrier film according to this embodiment, respectively.

The organic deposition device 24 forms a first organic layer 12 on a surface of a long strip of flexible film Z (film base) as it travels in a longitudinal direction.

On the other hand, the vacuum deposition device 26 forms a second organic layer 14 on the first organic layer 12, then an inorganic layer 16 on the second organic layer 14, and a third organic layer 18 on the inorganic layer 16 as the flexible film Z having the first organic layer 12 formed on its surface travels in the longitudinal direction.

Then, the organic deposition device 24 forms a fourth organic layer 20 on the third organic layer 18 as the flexible film Z having the first organic layer 12, the second organic layer 14, the inorganic layer 16 and the third organic layer 18 formed thereon travels in the longitudinal direction.

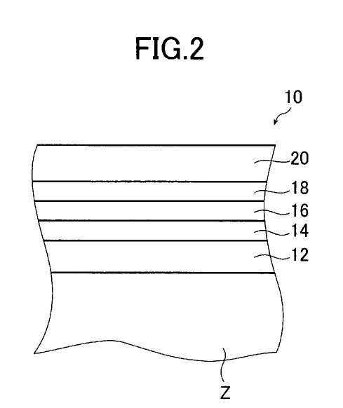

The devices shown in FIGS. 1A and 1B are used to produce a gas barrier film 10 as shown in FIG. 2. The gas barrier film produced may be used as an intermediate product.

The material of the flexible film Z is not particularly limited and various types of film in strip form used to produce gas barrier films may be used.

Specific examples of the flexible film Z that may be advantageously used include plastic films (resin films) in sheet form made of organic materials such as polyethylene terephthalate (PET), polyethylene naphthalate (PEN), polyethylene, polypropylene, polystyrene, polyamide, polyvinyl chloride, polycarbonate, polyacrylonitrile, polyimide, polyacrylate, and polymethacrylate.

The flexible film Z used may be one obtained by forming one or more than one layer to impart various functions on a plastic film base or other base. Exemplary layers include a protective layer, an adhesion layer, a light-reflecting layer, a light-shielding layer, a planarizing layer, a buffer layer, and a stress-relief layer.

A film having the first organic layer 12, the second organic layer 14, the inorganic layer 16 and optionally the third organic layer 18 may be used as the flexible film Z. The three or four layers are also hereinafter collectively referred to as “gas barrier laminate.” In other words, the gas barrier film of the present invention (gas barrier film having the gas barrier laminate in the present invention) is formed as an intermediate, which is used as the flexible film Z to form an organic layer and an inorganic layer thereon according to the present invention to produce a final gas barrier film of the present invention.

This point will be described later in further detail.

The organic deposition device 24 shown in FIG. 1A is a device where an organic material (organic compound) is deposited by a film deposition method at atmospheric pressure to form the first organic layer 12 on the surface of the flexible film Z. In addition, the organic deposition device 24 deposits an organic material to form the fourth organic layer 20 on the flexible film Z on which the second organic layer 14, the inorganic layer 16 and the third organic layer 18 have been formed by the vacuum deposition device 26 to be described later, thereby completing the gas barrier film 10 as shown in FIG. 2.

The organic deposition device 24 in the illustrated embodiment forms the first organic layer 12 and optionally the fourth organic layer 20 by a coating method, and includes a rotary shaft 28, a take-up shaft 30, a coating means 32, a drying means 34, a curing means 36, and guide rollers 38a and 38b. The coating means 32, the drying means 34, and the curing means 36 are disposed so as to face the travel path of the flexible film Z between the guide rollers 38a and 38b.

The organic deposition device 24 is a so-called roll-to-roll film deposition device in which the flexible film Z is fed from a film roll 40 having a long strip of flexible film Z wound into a roll, the first organic layer 12 or the fourth organic layer 20 (the fourth organic layer 20 is hereinafter omitted unless the fourth organic layer 20 is particularly necessary to distinguish or illustrate) is formed on the flexible film Z traveling in a longitudinal direction and the flexible film Z having the first organic layer 12 formed thereon is rewound on the take-up shaft 30.

In addition to the illustrated members, the organic deposition device 24 may also have various members of a device for continuously depositing a film by a coating method including various sensors, and various members (transport means) for making the flexible film Z travel along a predetermined path, as exemplified by a transport roller pair and a guide member for regulating the position in the width direction of the flexible film Z.

The flexible film Z fed from the film roll 40 is guided by the guide roller 38a to reach the coating means 32.

The coating means 32 applies to a surface of the flexible film Z on which a gas barrier laminate is to be deposited, a coating material containing an organic material making up the first organic layer 12 such as a coating material prepared by dissolving or dispersing an organic material in a solvent, a coating material prepared by dissolving an organic monomer in a solvent, or a coating material prepared by dissolving an organic monomer and a polymerization initiator in a solvent.

The coating method used in the coating means 32 is not particularly limited and various known methods used to form a coating can be used, as exemplified by roll coating, gravure coating, knife coating, dip coating, curtain flow coating, spray coating, bar coating, and spin coating.

The drying means 34 evaporates the solvent from the coating or coating material applied to the surface of the flexible film Z in the coating means 32 to dry the coating. The drying means 34 is not particularly limited and known drying means suitable to the coating applied such as drying with a heater or hot air drying may be used.

In cases where the coating is sufficiently viscous and thixotropic to enable the first organic layer 12 to be formed by merely curing the coating in the downstream curing means 36, it is not necessary to provide the drying means 34.

The curing means 36 cures the dried coating to form the first organic layer 12. In cases where the coating material contains an organic monomer as described above, the curing means 36 polymerizes the monomer to form the first organic layer 12.

The curing means 36 is not particularly limited and curing means suitable to the organic material used to form the first organic layer 12 may be appropriately selected and used, as exemplified by plasma irradiation means (plasma curing), ultraviolet (UV) irradiation means (UV curing), electron beam irradiation means (electron beam curing), light irradiation means (light curing), and heating means (thermal curing).

The curing means 36 may not be provided in cases where the coating can be fully cured to form the first organic layer 12 by merely drying. Alternatively, if drying and curing can be performed in a single means, only one of the drying means and the curing means may be provided to serve as a drying/curing means.

In the organic deposition device 24, the film roll 40 is mounted on the rotary shaft 28. Once the film roll 40 has been mounted on the rotary shaft 28, the flexible film Z is fed from the film roll 40 and travels on a predetermined travel path as it is guided by the guide rolls 38a and 38b to be wound on the take-up shaft 30.

Once the coating means 32, the drying means 34 and the curing means 36 are ready to start the treatments, the flexible film Z starts to travel. Feeding of the flexible film Z from the film roll 40 and winding of the flexible film Z on the take-up shaft 30 are performed in synchronism so that during the travel of the flexible film Z in the longitudinal direction, the coating means 32 applies a coating material to form the first organic layer 12, the drying means 34 dries the applied coating material and the curing means 36 cures the coating to form the first organic layer 12 on the surface of the flexible film Z.

In the present invention, the method of forming the first organic layer 12 is not limited to the coating method, and various film deposition methods including a transfer method in which the first organic layer 12 formed into a sheet shape is transferred to the flexible film can be all used as long as the method applied is capable of forming a layer or a film of an organic material at atmospheric pressure.

However, the coating method is used with advantage in consideration of the film deposition rate and the covering of the surface topographic features of the flexible film.

The first organic layer 12 is not limited to an organic monolayer formed at atmospheric pressure and a plurality of organic sublayers may be formed at atmospheric pressure to serve as the first organic layer 12. In other words, the first organic layer 12 in the present invention may include a plurality of organic sublayers formed by a film deposition method at atmospheric pressure such as the coating method.

In this regard, the same holds true for the second organic layer 14, the inorganic layer 16, the third organic layer 18, and the fourth organic layer 20 to be described later. For example, the second layer 14 may include a plurality of organic sublayers formed by flash evaporation. Alternatively, the inorganic layer 16 may include a plurality of inorganic sublayers formed by plasma-enhanced CVD.

The plurality of sublayers making up the first organic layer 12 and the inorganic layer 16 may be made of the same material or different materials.

The material used to form the first organic layer 12 is not particularly limited and various organic materials capable of film deposition or film formation at atmospheric pressure as in the coating method can be used.

Exemplary materials include epoxy resins, (meth)acrylic resins, polyesters, methacrylic acid/maleic acid copolymers, polystyrenes, transparent fluororesins, polyimides, fluorinated polyimides, polyamides, polyamideimides, polyetherimides, cellulose acylates, polyurethanes, polyetherketones, polycarbonates, fluorene ring-modified polycarbonates, alicyclic ring-modified polycarbonates, and fluorene ring-modified polyesters.

The flexible film Z on which the first organic layer 20 has been thus formed is guided by the guide roller 38b on the predetermined path to be wound on the take-up shaft 30 into a roll.

The flexible film Z wound on the take-up shaft 30 is supplied to the vacuum deposition device 26 as a film roll 42.

The vacuum deposition device 26 forms the second organic layer 14, the inorganic layer 16 and the third organic layer 18 on the flexible film Z having the first organic layer 12 formed thereon.

The vacuum deposition device 26 is also the same type roll-to-roll device as the organic deposition device 24. The second organic layer 14, the inorganic layer 16 and the third organic layer 18 are sequentially formed on the first organic layer 12 of the flexible film Z fed from the film roll 42 as it travels in the longitudinal direction, and the flexible film Z having these layers formed thereon is then rewound into a roll.

The vacuum deposition device 26 includes a feed chamber 46, a vacuum deposition chamber 48 and a take-up chamber 50.

In addition to the illustrated members, the vacuum deposition device 26 may also have various members of a device in which film deposition by a coating method, film deposition by flash evaporation and film deposition by vapor-phase deposition are continuously carried out on a long strip of flexible film Z, including various sensors, and various members (transport means) for making the flexible film Z travel along a predetermined path, as exemplified by a transport roller pair and a guide member for regulating the position in the width direction of the flexible film Z.

The feed chamber 46 includes a rotary shaft 52, a guide roller 54a and a vacuum evacuation means 55.

The film roll 42 is mounted on the rotary shaft 52 of the feed chamber 46. Upon mounting of the film roll 42 on the rotary shaft 52, the flexible film Z travels along a predetermined travel path starting from the feed chamber 46 and passing through the vacuum deposition chamber 48 to reach a take-up shaft 106 of the take-up chamber 50.

In the vacuum deposition device 26, feeding of the flexible film Z from the film roll 42 and winding of the flexible film Z on the take-up shaft 106 of the take-up chamber 50 are carried out in synchronism so that the second organic layer 14, the inorganic layer 16 and the third organic layer 18 may be sequentially formed in the vacuum deposition chamber 48 on the first organic layer 12 having already been formed on the surface of the flexible film Z as the long strip of flexible film Z travels on the predetermined travel path in the longitudinal direction.

The travel speed of the flexible film Z in the vacuum deposition device 26 is not particularly limited and a travel speed of at least 10 m/min is preferred.

As described above, in a conventional gas barrier film having an organic layer formed by flash evaporation and an inorganic layer formed by vapor-phase deposition, the organic layer has a larger thickness and therefore may not be deposited by flash evaporation to a desired thickness before the formation of the inorganic layer is started. In such a case, since the travel speed of the flexible film cannot be improved, gas barrier films cannot be produced at high speed with high efficiency.

In contrast, the present invention in which film deposition at atmospheric pressure as by the coating method is combined with film deposition in vacuum (at reduced pressure) as by flash evaporation to form two organic layers and an inorganic layer is formed thereon is capable of considerably improving the organic layer film deposition rate. Therefore, the present invention considerably improves the travel speed of the flexible film Z in the production of gas barrier films and is capable of obtaining gas barrier films at high speed with high production efficiency.

In other words, by setting the travel speed of the flexible film Z to 10 m/min or more, the characteristic feature of the present invention that the travel speed of the flexible film can be improved is fully achieved to enable the gas barrier films with high gas barrier properties to be produced with high productivity or at a high speed.

In consideration of this point, the travel speed of the flexible film Z is more preferably set to at least 30 m/min.

The vacuum evacuation means 55 is provided in a preferred embodiment to evacuate the feed chamber 46 to reduce the pressure to a predetermined value.

In other words, the feed chamber 46 communicates with the vacuum deposition chamber 48 through a slit 58a to be described later and therefore the feed chamber 46 can be prevented from adversely affecting the pressure of the vacuum deposition chamber 48 by keeping the feed chamber 46 at a predetermined pressure or degree of vacuum by the vacuum evacuation means 55.

In the present invention, the feed chamber 46 and the take-up chamber 50 to be described later are not limited to a structure having a vacuum evacuation means, and may be used at atmospheric pressure.

The vacuum evacuation means 55 is not particularly limited, and exemplary means that may be used include vacuum pumps such as a turbo pump, a mechanical booster pump, a rotary pump and a dry pump, an assist means such as a cryogenic coil, and various other known (vacuum) evacuation means employed in vacuum deposition devices and using means for adjusting the ultimate degree of vacuum or the amount of air discharged.

In this regard, the same holds true for the other vacuum evacuation means described later.

The flexible film Z is guided by the guide roller 54a to travel from the feed chamber 46 to the vacuum deposition chamber 48 separated from the feed chamber 46 by a partition wall 56a. The partition wall 56a has the slit 58a through which the flexible film Z passes.

The vacuum deposition chamber 48 sequentially forms the second organic layer 14, the inorganic layer 16 and the third organic layer 18 on the flexible film Z having the first organic layer 12 formed thereon.

In the present invention, the second organic layer 14, the inorganic layer 16 and the third organic layer 18 are all formed by film deposition in vacuum (under reduced pressure).

In the illustrated case, the vacuum deposition chamber 48 includes a second organic layer deposition unit 60 for forming the second organic layer 14, an inorganic layer deposition unit 62 for forming the inorganic layer 16, a third organic layer deposition unit 64 for forming the third organic layer 18, a drum 68, guide rollers 54b and 54c, and a vacuum evacuation means 70.

The second organic layer deposition unit 60, the inorganic layer deposition unit 62 and the third organic layer deposition unit 64 are respectively separated from the other regions (other spaces) in a substantially air-tight manner by the drum 68 and partition walls 72a and 72b extending from the wall surface of the vacuum deposition chamber 48 to the vicinity of the drum 68, by the drum 68 and partition walls 72b and 72c, and by the drum 68 and partition walls 72c and 72d.

The vacuum evacuation means 70 is used to keep the space separated from the film deposition units in a substantially air-tight manner by the drum 68 and the partition walls 72a and 72d at a predetermined degree of vacuum.

The space in the vacuum deposition chamber 48 communicates with the feed chamber 46 and the take-up chamber 50 through the slits 58a and 58b, respectively. Therefore, the vacuum evacuation means 70 adjusts the degree of vacuum in this space based on the film deposition pressure in the second organic layer deposition unit 60 and the third organic layer deposition unit 64 for forming the organic layers in vacuum, whereby the pressure in the upstream and downstream chambers can be prevented from adversely affecting the film deposition pressure in the second organic layer deposition unit 60 and the third organic layer deposition unit 64.

In the illustrated vacuum deposition chamber 48, the space evacuated by the vacuum evacuation means 70 and the second organic layer deposition unit 60, the second organic layer deposition unit 60 and the inorganic layer deposition unit 62, the inorganic layer deposition unit 62 and the third organic layer deposition unit 64, and the third organic layer deposition unit 64 and the space evacuated by the vacuum evacuation means 70 are separated from each other in a substantially air-tight manner by the partition walls 72a, 72b, 72c, 72d, respectively.

However, this is not the sole case of the present invention and a differential unit serving as the space for substantially air-tight isolation and provided with a pressure adjusting means such as a vacuum evacuation means to keep the pressure at a predetermined degree of vacuum may be disposed between the space evacuated by the vacuum evacuation means 70 and its adjacent film deposition unit and/or between the adjacent film deposition units so that the respective spaces may be more reliably separated (isolated) from each other.

The guide rollers 54b and 54c are of an ordinary type guiding the flexible film Z on the predetermined travel path.

The drum 68 is a cylindrical member which is rotatable about a rotary shaft disposed in the width direction of the flexible film Z which is perpendicular to the direction of travel. The flexible film Z is guided by the guide roller 54b on the predetermined path, passes over a predetermined region of the peripheral surface of the drum 68 and sequentially travels through the second organic layer deposition unit 60, the inorganic layer deposition unit 62 and the third organic layer deposition unit 64 before reaching the guide roller 54c.

The drum 68 also serves as a counter electrode of a shower head electrode 90 in the inorganic layer deposition unit 62 to be described later. To this end, the drum 68 is connected to a bias power source or grounded (connection is not shown in both the cases). Alternatively, the drum 68 may be capable of switching between connection to the bias power source and grounding.

The drum 68 may also serve as a temperature adjusting means of the flexible film Z for aggregation of an organic liquid in the second organic layer deposition unit 60 or the third organic layer deposition unit 64 or suppressing the temperature increase of the flexible film during the film deposition. Therefore, the temperature adjusting means is preferably built into the drum 68. The temperature adjusting means of the drum 68 is not particularly limited and various types of temperature adjusting means including one in which a refrigerant is circulated and a cooling means using a piezoelectric element can be all used.

The second organic layer deposition unit 60 is a unit where an organic material is deposited by a vacuum deposition method on the surface of the first organic layer 12 formed on the flexible film Z to form the second organic layer 14 thereon. In a preferred embodiment, the illustrated second organic layer deposition unit 60 forms the second organic layer 14 by flash evaporation and includes a vapor deposition section 74, a curing means 76, an organic material supply section 78 and a vacuum evacuation means 80.

In flash evaporation, as is well known, a film material is evaporated and the vapor is deposited on the flexible film, and cooled/condensed to form a liquid film, which is then cured by exposure to ultraviolet light or electron beams to finally form a film.

The vacuum evacuation means 80 evacuates the second organic layer deposition unit 60, that is, the closed spaced defined by the partition walls 72a and 72b and the peripheral surface of the drum 68 to adjust the pressure to a degree of vacuum (film deposition pressure) suitable to the flash evaporation in the second organic layer deposition unit 60.

The film deposition pressure in the flash evaporation is not particularly limited and is, for example, from about 0.1 to about 100 Pa.

The organic material supply section 78 vaporizes an organic monomer in liquid form or a coating material obtained by dissolving an organic monomer and optionally a polymerization initiator in a solvent by application of heat or ultrasound and supplies the vaporized monomer through a pipe 74a to the vapor deposition section 74. In the illustrated embodiment, the organic monomer in liquid form is used as the material of the second organic layer 14.

The vapor deposition section 74 ejects and deposits the vaporized organic monomer supplied from the organic material supply section 78 onto the first organic layer which has already been formed on the surface of the flexible film Z traveling on the drum 68. The organic monomer is thus deposited to form the second organic layer 14.

For example, the differential pressure between the inside of the organic material supply section 78 and the inside of the second organic layer deposition unit 60 may be used to move the vaporized material from the organic material supply section 78 to the vapor deposition section 74 and to eject the vaporized material from the vapor deposition section 74.

Although not shown, the vapor deposition unit 74 is provided with a heat control means and heating nozzles for heating the environment to a temperature which is not less than the aggregation temperature but not more than the evaporation temperature of the material used.

The vaporized monomer supplied from the organic material supply section 78 passes through the heating nozzles to form a certain amount of deposits on the first organic layer 12 of the flexible film Z. The drum 68 is preferably cooled to improve the aggregation efficiency of the monomer.

The curing means 76 cures the organic material deposited on the first organic layer 12 to form the second organic layer 14. A UV irradiation means for irradiating the flexible film Z on the drum 68 with UV light may be used for the curing means 76.

An electron beam irradiation means for emitting electron beams, a microwave irradiation means for emitting microwaves and a plasma irradiation means for plasma irradiation may be advantageously used as the curing means 76 for curing the deposited organic materials.

In the present invention, the method of forming the second organic layer 14 is not limited to flash evaporation and various methods capable of forming the organic layer in vacuum may be used, as exemplified by plasma polymerization.

However, flash evaporation is more advantageously used in terms of the surface smoothness of the second organic layer 14, the quality (e.g., purity) of the film to be formed, film deposition rate, long-term stability and ease of maintenance.

The material used to form the second organic layer 14 is not particularly limited and various materials capable of film deposition or film formation in vacuum or at reduced pressure as by flash evaporation can be used.

Exemplary materials include (meth)acrylic resins, epoxy resins, polyesters, methacrylic acid/maleic acid copolymers, polystyrenes, transparent fluororesins, polyimides, fluorinated polyimides, polyamides, polyamideimides, polyetherimides, cellulose acylates, polyurethanes, polyetherketones, polycarbonates, fluorene ring-modified polycarbonates, alicyclic ring-modified polycarbonates, and fluorene ring-modified polyesters.

The material of the first organic layer 12 may be the same as or different from that of the second organic layer 14, but both the layers are preferably made of the same type of material and more preferably the same material in terms of the surface smoothness and the adhesion.

The same type of material refers to a material in which the functional group or the binding group characterizing the organic material used is of the same type and the main component is the same. For example, when the first organic layer 12 is made of acrylic resin, the second organic layer 14 is also made of acrylic resin, and when the first organic layer 12 is made of polyimide, the second organic layer 14 is also made of polyimide. The materials which contain the same main component are deemed as those of the same type even if there are differences in various additives (auxiliary components) used such as an adhesion promoter and the amounts thereof.

The inorganic layer deposition unit 62 is a unit where an inorganic material or inorganic compound is deposited on the surface of the second organic layer 14 by vacuum vapor-phase deposition to form the inorganic layer 16 thereon.

The inorganic layer deposition unit 62 in the illustrated embodiment forms the inorganic layer 16 by capacitively coupled plasma CVD (hereinafter abbreviated as “CCP-CVD”) and includes the shower head electrode 90, a material gas supply section 92, an RF power source 94, and a vacuum evacuation means 96.

The shower head electrode 90 is of a known type used in film deposition by means of CCP-CVD.

In the illustrated embodiment, the shower head electrode 90 is in the form of a hollow and substantially rectangular solid and is disposed so that its largest surface faces the peripheral surface of the drum 68 and the perpendicular from the center of the largest surface coincides with the normal of the drum 68 with respect to its peripheral surface. A large number of through holes are formed at the whole surface of the shower head electrode 90 facing the drum 68. In a preferred embodiment, the surface of the shower head electrode 90 facing the drum 68 is so curved as to contour the peripheral surface of the drum 68.

In the illustrated embodiment, one shower head electrode (film deposition means using CCP-CVD) is provided in the inorganic layer deposition unit 62. However, this is not the sole case of the present invention and a plurality of shower head electrodes may be disposed in the direction of travel of the flexible film Z. In this regard, the same holds true when using plasma-enhanced CVD of other type than CCP-CVD. For example, when the inorganic layer 16 is formed by ICP-CVD, a plurality of coils for forming an induced electric field (induced magnetic field) may be provided along the direction of travel of the flexible film Z.

The present invention is not limited to the case in which the inorganic layer 16 is formed by ICP-CVD using the shower head electrode 90; the inorganic layer 16 may be formed by using a common electrode in plate form and a gas supply nozzle.

The material gas supply section 92 is of a known type used in vacuum deposition devices such as plasma CVD devices, and supplies material gases into the shower head electrode 90. For example, in cases where the inorganic layer 16 formed is a silicon nitride layer or film, material gases including silane gas, ammonia gas and optionally an inert gas are supplied to the shower head electrode 90.

As described above, a large number of through holes are formed at the surface of the shower head electrode 90 facing the drum 68. Therefore, the material gases supplied into the shower head electrode 90 pass through the through-holes to be introduced into the space between the shower head electrode 90 and the drum 68.

The RF power source 94 is one for supplying plasma excitation power to the shower head electrode 90. Known RF power sources used in various plasma CVD devices can be all used for the RF power source 94.

In addition, the vacuum evacuation means 96 evacuates the inorganic layer deposition unit 62, i.e., the closed space defined by the partition wall 72b, the partition wall 72c, and the peripheral surface of the drum 68, to keep it at a predetermined film deposition pressure in order to form the gas barrier film by plasma-enhanced CVD.

In the present invention, the method of forming the inorganic layer 16 is not limited to the foregoing CCP-CVD, and vapor-phase deposition methods carried out in vacuum are all applicable as long as the inorganic layer 16 can be formed. Examples thereof include other types of plasma-enhanced CVD such as inductively coupled plasma CVD (ICP-CVD) and microwave plasma CVD, catalytic CVD (Cat-CVD), thermal CVD, sputtering, vacuum evaporation, and ion plating.

The material of the inorganic layer 16 formed is not particularly limited and various inorganic materials used to form gas barrier films exhibiting good gas barrier properties can be used.

Illustrative examples include metal oxides such as aluminum oxide, magnesium oxide, tantalum oxide, zirconium oxide, titanium oxide and indium tin oxide (ITO); metal nitrides such as aluminum nitride; metal carbides such as aluminum carbide; silicon oxides such as silicon oxynitride, silicon oxycarbide and silicon oxynitrocarbide; silicon nitrides such as silicon nitride and silicon carbonitride; silicon carbides such as silicon carbide; hydrides thereof; mixtures of two or more thereof; and those materials containing hydrogen.

In the production method of the present invention, the first organic layer 12 is formed by a film deposition method at atmospheric pressure such as the coating method, then the second organic layer 14 is formed by vacuum film deposition such as flash evaporation, and the inorganic layer 16 mainly exhibiting gas barrier properties is formed on the second organic layer 14 by vacuum vapor-phase deposition, thereby forming a gas barrier laminate to produce a gas barrier film.

Laminate-type gas barrier films as also described in JP 2003-341003 A and U.S. Pat. No. 6,420,003 are known in which a flexible film such as a plastic film is coated with an organic layer, which is then coated with an inorganic layer, which is optionally coated with another organic layer.

In such a laminate-type gas barrier film, the organic layer underlying the inorganic layer is formed to cover the surface topographic features of the flexible film to thereby form a highly smooth surface, and the inorganic layer made of, for example, an inorganic oxide and exhibiting gas barrier properties is formed on the highly smooth surface to obtain a gas barrier film having excellent gas barrier properties.

Flash evaporation is a preferred method used to form the organic layer because the organic layer obtained has a highly clean and smooth surface.

On the other hand, the inorganic layer is typically formed by vapor-phase deposition techniques such as plasma-enhanced CVD.

The organic layer formed as the underlayer of the inorganic layer needs to have a considerably larger thickness than the inorganic layer to reliably cover topographic features of the flexible film Z to thereby achieve high surface smoothness. The difference between the thickness of the organic layer and that of the inorganic layer may hinder the improvement of the productivity. More specifically, in the illustrated case where the organic layer and the inorganic layer are continuously formed as the flexible film Z travels, the thicker organic layer cannot be deposited by flash evaporation to a predetermined thickness before starting the deposition of the thinner inorganic layer by vapor-phase deposition to a predetermined thickness, thus giving rise to a need to decrease the film deposition rate of the inorganic layer.

Therefore, in the production of a gas barrier film which involves forming a first organic layer by flash evaporation, forming an inorganic layer on the first organic layer and optionally forming a second organic layer on the inorganic layer by flash evaporation, the gas barrier film obtained has excellent gas barrier properties by taking advantage of the characteristics of flash evaporation, but the flash evaporation is a rate-limiting factor which makes it difficult to improve the productivity.

Therefore, in the production method in which the organic layer and inorganic layer are sequentially formed as the flexible film travels in the longitudinal direction as in the illustrated roll-to-roll film deposition device, the flexible film Z cannot travel at high speed, which hinders the improvement of the productivity and the production efficiency.

In contrast, in the embodiment under consideration, the first organic layer 12 is first formed on the surface of the flexible film Z by a film deposition method at atmospheric pressure such as the coating method, and the second organic layer 14 is formed on the first organic layer 12 by a vacuum film deposition method such as the flash evaporation; the two organic layers are then used as the underlayer to form the inorganic layer 16 thereon by vacuum vapor-phase deposition.

As is well known, the film deposition rate of the organic layer formed at atmospheric pressure by such a typical method as the coating method is higher than that of the inorganic layer formed by a vapor-phase deposition method such as plasma-enhanced CVD to enable a thick film to be formed in a short period of time. On the other hand, the organic layer formed by flash evaporation has excellent surface smoothness and also has high surface cleanness because it is formed in vacuum.

In addition, the inorganic layer 16 formed on the second organic layer 14 is also formed in vacuum in this embodiment, and therefore the treatments from the formation of the second organic layer 14 to the end of the formation of the inorganic layer 16 can be performed in vacuum as shown in the embodiment of FIG. 1B. Therefore, after the end of the formation of the second organic layer 14, adhesion of dust and foreign matter is advantageously prevented to enable the inorganic layer 16 to be formed with the surface kept clean, the surface cleanness being one of the characteristics of flash evaporation. In other words, there is no dust or foreign matter on the surface of the second organic layer 14 on which the inorganic layer 16 is to be formed, thereby preventing the reduction of the gas barrier properties.

In view of this, in the present invention, after the end of the formation of the second organic layer 14, the inorganic layer 16 is preferably formed with no member (solid surface thereof) contacting the surface of the second organic layer 14 (particularly the region used for a product) as in the vacuum deposition device 26 shown in FIG. 1B. Such a configuration can suppress adhesion of dust and foreign matter while preventing damage to the second organic layer 14 due to contact with a member and its surface deformation, thus enabling the inorganic layer 16 to be formed on the surface having higher smoothness and cleanness.

In addition, the first organic layer 12 and the second organic layer 14 are each made of an organic film and are therefore highly compatible with each other. Particularly in cases where the same type of material is used, the first organic layer 12 and the second organic layer 14 have good adhesion and can be deemed as a monolayer film.

In addition, according to the embodiment under consideration, the first organic layer 12 substantially covers large topographic features of the flexible film Z, and then the second organic layer 14 can cover topographic features that may be inevitably caused somewhat by the subsequent handling of the flexible film including its traveling (e.g., flaws that may occur during the winding of the flexible film Z into a roll and topographic features due to foreign matter that may adhere during the traveling of the flexible film Z in vacuum).

Therefore, the second organic layer 14 formed in vacuum just before the formation of the inorganic layer 16 can also have a reduced thickness.

In other words, the organic layer having a sufficiently large thickness can be formed at a rate fully matching the film deposition rate of the inorganic layer 16 formed by vapor-phase deposition, and the inorganic layer 16 can be formed on the organic layer by taking advantage of favorable characteristics of the organic layer formed in vacuum as by flash evaporation (e.g., surface smoothness and cleanness).

Therefore, according to the embodiment under consideration, in the production method in which the organic layer and the inorganic layer are formed as the flexible film travels in the longitudinal direction as in the production device shown in FIGS. 1A and 1B in which film deposition is performed by a roll-to-roll system, the flexible film Z can be made to travel at high speed to achieve high productivity and production efficiency and the inorganic layer 16 can be formed on the organic layer having high surface smoothness and cleanness to obtain a gas barrier film having excellent gas barrier properties.

There is no particular limitation on the thickness of the first organic layer 12 and the second organic layer 14 formed so as to be adjacent to each other but the total thickness of the two layers is preferably from 0.3 to 5 μm.

In addition, the second organic layer 14 preferably has a thickness which is not more than 0.5 μm or not more than 50% of the total thickness of the first organic layer 12 and the second organic layer 14. The second organic layer 14 preferably has a thickness which is at least 0.1 μm or at least 20% of the total thickness of the two layers.

Such a configuration yields favorable results in that a sufficiently high thickness to cover topographic features of the flexible film Z can be ensured and that the flexible film Z can be made to travel at high speed to achieve higher productivity and production efficiency.

The thickness of the inorganic layer 16 is also not particularly limited and may be appropriately set according to the required gas barrier properties and productivity. However, the inorganic layer 16 preferably has a thickness of 10 to 300 nm.

At a thickness of the inorganic layer 16 within the above-defined range, favorable results can be obtained in that excellent gas barrier properties can be achieved, good flexibility can be achieved, good transparency can be achieved, and sufficiently high durability (environmental resistance) can be achieved.

The third organic layer deposition unit 64 is a unit where an organic film is deposited on the inorganic layer 16 to form the third organic layer 18 thereon.

In the illustrated embodiment, the third organic layer deposition unit 64 forms the third organic layer 18 by flash evaporation as in the second organic layer deposition unit 60. Therefore, a vapor deposition section 98, a curing means 100, an organic material supply section 102, and a vacuum evacuation means 104 in the third organic layer deposition unit 64 are the same as the vapor deposition section 74, the curing means 76, the organic material supply section 78 and the vacuum evacuation means 80 in the second organic layer deposition unit 60, respectively.

As in the second organic layer 14, the method of forming the third organic layer 18 is not limited to flash evaporation and various methods capable of forming an organic layer in vacuum may be all used.

However, flash evaporation is also used with advantage to form the third organic layer 18 for the same reason as the second organic layer 14.

The third organic layer 18 is formed in a preferred embodiment.

Also as a preferred embodiment, the gas barrier film 10 shown in FIG. 2 has a fourth organic layer 20 formed as the uppermost layer by a film deposition method at atmospheric pressure such as the coating method. As will be described later in detail, the gas barrier film of the present invention may have a plurality of gas barrier laminates, each gas barrier laminate including the first organic layer 12, the second organic layer 14, the inorganic layer 16 and optionally the third organic layer 18.

That is, the presence of the third organic layer 18 enables the first organic layer 12 and the fourth organic layer 20 to be formed on the surface made of an organic material by a film deposition method in the air such as the coating method. In other words, the underlying layer on which the organic layer is to be formed at atmospheric pressure is made of an organic material. Such a configuration enables the adhesion of the first organic layer 12 and the fourth organic layer 20 to be considerably improved compared to the case where the first organic layer 12 or the fourth organic layer 20 is directly formed on the inorganic layer 16, and the gas barrier film 10 can have considerably improved strength.

The third organic layer 18 is also formed by a vacuum film deposition method such as flash evaporation. Therefore, the first organic layer 12 and the fourth organic layer 20 can be formed on the underlying layer having a highly smooth surface to achieve higher adhesion.

The treatments from the formation of the inorganic layer 16 to the end of the formation of the third organic layer 18 can be performed in vacuum. In other words, the gas barrier film is discharged to the atmosphere after the formation of the inorganic layer 16 and the third organic layer 18, and therefore is not exposed to atmospheric pressure. Therefore, adhesion of dust and foreign matter to the surface of the inorganic layer 16 and damage to the inorganic layer 16 can be advantageously prevented from occurring. Accordingly, the gas barrier properties can be prevented from being reduced by the adhesion of dust or foreign matter to the inorganic layer 16.

In view of this, after the formation of the inorganic layer 16, the third organic layer 18 is preferably formed with no member contacting the surface of the inorganic layer 16 (particularly the region used for a product) as in the vacuum deposition device 26 shown in FIG. 1B. Such a configuration can more reliably suppress adhesion of dust and foreign matter while preventing damage to the inorganic layer 16 due to contact with a member and its surface deformation, thereby achieving good gas barrier properties.

The material used to form the third organic layer 18 in the present invention is not particularly limited and various organic materials capable of film formation in vacuum as by flash evaporation can be used.

Exemplary materials include epoxy resins, (meth)acrylic resins, polyesters, methacrylic acid/maleic acid copolymers, polystyrenes, transparent fluororesins, polyimides, fluorinated polyimides, polyamides, polyamideimides, polyetherimides, cellulose acylates, polyurethanes, polyetherketones, polycarbonates, fluorene ring-modified polycarbonates, alicyclic ring-modified polycarbonates, and fluorene ring-modified polyesters.

The thickness of the third organic layer 18 is also not particularly limited and is preferably from about 0.1 to about 0.5 μm.

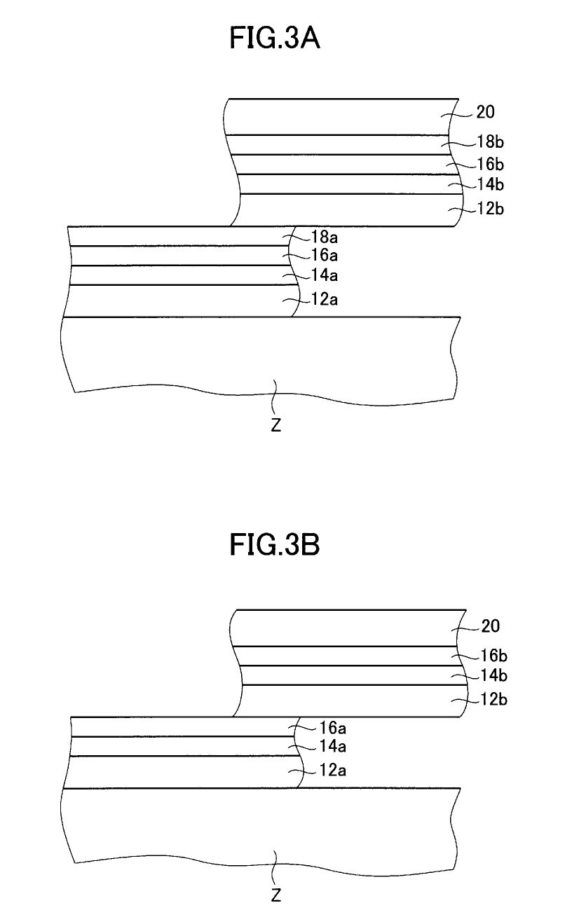

In cases where a plurality of gas barrier laminates are formed as described above, the third organic layer 18, the first organic layer 12 and the second organic layer 14 formed so as to be adjacent to each other (see the third organic layer 18a, the first organic layer 12b and the second organic layer 14b in FIG. 3A) preferably have a total thickness of 0.3 to 5 μm. In addition, the second organic layer 14 and the third organic layer 18 preferably have a thickness which is not more than 0.5 μm or not more than 25% of the total thickness of the third organic layer 18, the first organic layer 12 and the second organic layer 14.

Such a configuration yields favorable results in that a sufficiently high thickness to cover topographic features of the flexible film Z can be ensured and that the flexible film Z can be made to travel at high speed to achieve higher productivity and production efficiency.

The flexible film Z having the third organic layer 18 formed in the third organic layer deposition unit 64 is then guided by the guide roller 54c to reach the take-up chamber 50 which is separated from the vacuum deposition chamber 48 by a partition wall 56b. The partition wall 56b has the slit 58b through which the flexible film Z passes.

The flexible film Z having reached the take-up chamber 50 travels to the take-up shaft 106 as it is guided by a guide roller 54d and is wound on the take-up shaft 106 to form a film roll 110 into which the flexible film Z having the first organic layer 12, the second organic layer 14, the inorganic layer 16 and the third organic layer 18 formed thereon is wound. In a preferred embodiment, the take-up chamber 50 also includes a vacuum evacuation means 108 as in the above-described feed chamber 46, and is evacuated to a predetermined pressure based on the pressure of the vacuum deposition chamber 48 to prevent the take-up chamber 50 from adversely affecting the pressure of the vacuum deposition chamber 48.

The operation of the vacuum deposition device 26 is described below.

As described above, upon mounting of the film roll 42 on the rotary shaft 52, the flexible film Z is let out from the film roll 42 to travel on the predetermined travel path. More specifically, the flexible film Z travels in the feed chamber 46 and is guided by the guide roller 54a to reach the vacuum deposition chamber 48, where the flexible film Z is guided by the guide roller 54b to travel on the predetermined region of the peripheral surface of the drum 68 and is then guided by the guide roller 54c to reach the take-up chamber 50, where the flexible film Z reaches the take-up shaft 106 as it is guided by the guide roller 54d.

The vacuum evacuation means 80 evacuates the second organic layer deposition unit 60 to a predetermined degree of vacuum suitable to the formation of the second organic layer 14 by flash evaporation, the vacuum evacuation means 104 evacuates the third organic layer deposition unit 64 to a predetermined degree of vacuum suitable to the formation of the third organic layer 18 by flash evaporation, and the vacuum evacuation means 70 evacuates the region communicating with the feed chamber 46 and the take-up chamber 50 to a predetermined degree of vacuum suitable to the flash evaporation.

In addition, in the inorganic layer deposition unit 62, the material gas supply section 92 supplies to the shower head electrode 90 material gases suitable to the inorganic layer 16 to be formed, and the vacuum evacuation means 96 evacuates the inorganic layer deposition unit 62 to a predetermined degree of vacuum suitable to the formation of the inorganic layer 16 by CCP-CVD.

Furthermore, the vacuum evacuation means 55 and 108 evacuate the feed chamber 46 and the take-up chamber 50 to predetermined degrees of vacuum based on the pressure of the vacuum deposition chamber 48, respectively.

Once the amounts of material gases supplied and the pressure in all the film deposition units have stabilized, the flexible film Z starts traveling from the feed chamber 46 toward the take-up chamber 50, and the second organic layer deposition unit 60 starts ejecting a vaporized monomer for use in forming the second organic layer 14 from the organic material supply section 78 to the vapor deposition section 74 and irradiating UV light from the curing means 76. The inorganic layer deposition unit 62 starts supplying plasma excitation power from the RF power source 94 to the shower head electrode 90. The third organic layer deposition unit 64 starts ejecting a vaporized monomer for used in forming the third organic layer 18 from the organic material supply section 102 to the vapor deposition section 98 and irradiating UV light from the curing means 100.

The flexible film Z fed from the feed chamber 46 and guided by the guide roller 54a on the predetermined path first travels to the vacuum deposition chamber 48.

The flexible film Z having reached the vacuum deposition chamber 48 travels on the drum 68 as it is guided by the guide roller 54b on the predetermined path, and the second organic layer 14, the inorganic layer 16 and the third organic layer 18 are sequentially formed on the flexible film Z in the second organic layer deposition unit 60, the inorganic layer deposition unit 62 and the third organic layer deposition unit 64, respectively, and the flexible film Z is then guided by the guide roller 54c on the predetermined path to reach the take-up chamber 50.

The flexible film Z having reached the take-up chamber 50 is guided by the guide roller 54d to be wound on the take-up shaft 106 to obtain the film roll 110 into which the flexible film Z having the first organic layer 12, the second organic layer 14, the inorganic layer 16 and the third organic layer 18 formed thereon is wound. The film roll 110 is fed again to the organic deposition device 24. Alternatively, the film roll 110 may be used in the next step as a gas barrier film or an intermediate product of gas barrier film.

The film roll 110 is fed again to the organic deposition device 24 to produce the gas barrier film 10 shown in FIG. 2 which has the fourth organic layer 20 formed on the third organic layer 18.

In the organic deposition device 24, upon mounting of the film roll 110 on the rotary shaft 28, the same treatments as for the first organic layer 12 are repeated: the coating means 32 applies a coating material for the fourth organic layer 20 and the coating material is dried by the drying means 34 and is then cured by the curing means 36 to form the fourth organic layer 20.

The flexible film Z having the fourth organic layer 20 formed thereon, that is, the gas barrier film 10 is wound on the take-up shaft 30 and fed to the next step as a gas barrier film or an intermediate product of gas barrier film.

In a preferred embodiment, the fourth organic layer 20 is an uppermost organic layer.

Favorable results can be obtained in that the fourth organic layer 20 can protect the gas barrier laminate including the first organic layer 12, the second organic layer 14, the inorganic layer 16 and optionally the third organic layer 18 against damage to obtain a gas barrier film having excellent strength and durability.

The thickness of the fourth organic layer 20 is not particularly limited and may be appropriately set according to the strength and thickness required for the gas barrier film 10. However, the fourth organic layer 20 preferably has a thickness of 0.3 to 5 μm.

At a thickness of the fourth organic layer 20 within the above-defined range, favorable results can be obtained in terms of the durability and mechanical strength of the gas barrier film 10.

The material used to form the fourth organic layer 20 is not particularly limited and various organic materials capable of film deposition at atmospheric pressure as in the coating method can be used.

Exemplary materials include epoxy resins, (meth)acrylic resins, polyesters, methacrylic acid/maleic acid copolymers, polystyrenes, transparent fluororesins, polyimides, fluorinated polyimides, polyamides, polyamideimides, polyetherimides, cellulose acylates, polyurethanes, polyetherketones, polycarbonates, fluorene ring-modified polycarbonates, alicyclic ring-modified polycarbonates, and fluorene ring-modified polyesters.

The gas barrier film of the present invention may have a plurality of gas barrier laminates each including the first organic layer 12, the second organic layer 14 and the inorganic layer 16, and optionally the third organic layer 18.

More specifically, as an example is shown in FIG. 3A, the gas barrier film may have a gas barrier laminate including a first organic layer 12a, a second organic layer 14a, an inorganic layer 16a and a third organic layer 18a which is overlaid with another gas barrier laminate including a first organic layer 12b, a second organic layer 14b, an inorganic layer 16b and a third organic layer 18b, and then with a fourth organic layer 20. Alternatively, the gas barrier film may have three or more such gas barrier laminates.

For example, such a gas barrier film may be produced as follows: From the second organic layer 14a to the third organic layer 18a are formed in the vacuum deposition device 26, after which the first organic layer 12b is formed in the organic deposition device 24; then, from the second organic layer 14b to the third organic layer 18b are formed in the vacuum deposition device 26 before the fourth organic layer 20 is formed in the organic deposition device 24.

As described above, the third organic layer 18 is formed in a preferred embodiment and therefore a film structure shown in FIG. 3B is also possible in which a gas barrier laminate including the first organic layer 12a, the second organic layer 14a and the inorganic layer 16a is overlaid with another gas barrier laminate including the first organic layer 12b, the second organic layer 14b and the inorganic layer 16b, and then the fourth organic layer 20. Alternatively, the gas barrier film may have three or more such gas barrier laminates.

As described above, the fourth organic layer 20 is also formed in a preferred embodiment.

The gas barrier film may have one or more gas barrier laminates each including the first organic layer 12, the second organic layer 14 and the inorganic layer 16, and one or more another gas barrier laminates each including the first organic layer 12, the second organic layer 14, the inorganic layer 16 and the third organic layer 18.

In other words, the gas barrier film shown in FIG. 2 may also have another set of the first organic layer 12, the second organic layer 14, the inorganic layer 16 and optionally the third organic layer 18, or a plurality of gas barrier laminates each composed of such organic layers and inorganic layer may be formed.

The above-described production device includes the organic deposition device 24 for forming the organic layer by coating and the vacuum deposition device 26 for vacuum film deposition as separate entities. However, this is not the sole case of the present invention and a gas barrier film may be formed by using a roll-to-roll film deposition device for forming from the first organic layer 12 to the fourth organic layer 20.

In this case, the device shown in FIG. 1B may be provided with a film deposition chamber similar to the organic deposition device 24 shown in FIG. 1A between the feed chamber 46 and the vacuum deposition chamber 48, and between the vacuum deposition chamber 48 and the take-up chamber 50.

However, as shown in FIGS. 1A and 1B, the film deposition device for forming the organic layer by coating and the film deposition device for film formation in vacuum are preferably provided as separate entities in terms of a higher degree of flexibility in the operating conditions of the manufacturing facility and the facility layout; for example, the film travel speed in the film deposition device by coating in which the film deposition rate is very high is made higher than that of the device in which vacuum film deposition is performed; and one device is used for film deposition by coating at a very high film deposition rate, whereas three devices are used for vacuum film deposition.

While the gas barrier film and the gas barrier film production method according to the present invention have been described above in detail, the present invention is by no means limited to the foregoing embodiments and it should be understood that various improvements and modifications may of course be made without departing from the scope and spirit of the invention.

The present invention is advantageously applicable to gas barrier films for use in manufacturing plasma displays and organic EL displays.

What is claimed is:

1. A gas barrier film comprising:
a flexible film;
a first organic layer formed at atmospheric pressure on a surface of said flexible film;
a second organic layer formed in vacuum on a surface of said first organic layer; and
an inorganic layer formed in vacuum on a surface of said second organic layer.

2. The gas barrier film according to claim 1, wherein a plurality of sets each comprising a combination of said first organic layer, said second organic layer and said inorganic layer are stacked on top of each other.

3. The gas barrier film according to claim 1, which further comprises a third organic layer formed in vacuum on a surface of said inorganic layer.

4. The gas barrier film according to claim 1, which further comprises a fourth organic layer formed at atmospheric pressure as an uppermost layer.

5. The gas barrier film according to claim 1, wherein said first organic layer and said second organic layer have a total thickness of 0.3 to 5 μm and said second organic layer has a thickness of not more than 0.5 μm.

6. The gas barrier film according to claim 1, wherein said first organic layer and said second organic layer have a total thickness of 0.3 to 5 μm and said second organic layer has a thickness which is not more than 50% of the total thickness of said first organic layer and said second organic layer.

7. The gas barrier film according to claim 3, wherein said first organic layer, said second organic layer and said third organic layer have a total thickness of 0.3 to 5 μm and each of said second organic layer and said third organic layer has a thickness of not more than 0.5 μm.

8. The gas barrier film according to claim 3, wherein said first organic layer, said second organic layer and said third organic layer have a total thickness of 0.3 to 5 μm and the thickness of each of said second organic layer and said third organic layer is not more than 25% of the total thickness of said first organic layer, said second organic layer and said third organic layer.

9. The gas barrier film according to claim 1, wherein said inorganic layer has a thickness of 10 to 300 nm.

10. The gas barrier film according to claim 1, wherein said inorganic layer comprises a material selected from the group consisting of metal oxides, metal nitrides, metal carbides, silicon oxides, silicon nitrides, silicon carbides, mixtures of two or more thereof, and those materials containing hydrogen.

11. The gas barrier film according to claim 1, wherein said first organic layer comprises a material whose main component is of a same type as that of said second organic layer.

12. The gas barrier film according to claim 1, wherein a moisture vapor transmission rate is not more than 1×10⁻³ g/(m²·day).

13. A method of producing a gas barrier film comprising the steps of:
making a flexible film in strip form travel in a longitudinal direction thereof;
forming a first organic layer at atmospheric pressure on a surface of the flexible film which is traveling;
forming a second organic layer in vacuum on a surface of said first organic layer; and
forming an inorganic layer in vacuum on a surface of said second organic layer.

14. The method of producing a gas barrier film according to claim 13, wherein after said second organic layer has been formed, no solid contacts a region used for a product on the surface of said second organic layer until said inorganic layer is formed.

15. The method of producing a gas barrier film according to claim 13, wherein the steps of forming said first organic layer, forming said second organic layer and forming said inorganic layer are carried out a plurality of times.

16. The method of producing a gas barrier film according to claim 13, further comprising a step of:
forming a third organic layer in vacuum on a surface of said inorganic layer.

17. The method of producing a gas barrier film according to claim 16, wherein after said inorganic layer has been formed, no solid contacts a region used for a product on the surface of said inorganic layer until said third organic layer is formed.

18. The method of producing a gas barrier film according to claim 13, further comprising a step of:
forming a fourth organic layer at atmospheric pressure as an uppermost layer.

19. The method of producing a gas barrier film according to claim 13, wherein said first organic layer is formed by coating.

20. The method of producing a gas barrier film according to claim 13, wherein said second organic layer is formed by flash evaporation.

21. The method of producing a gas barrier film according to claim 16, wherein said third organic layer is formed by flash evaporation.

22. The method of producing a gas barrier film according to claim 13, wherein said flexible film travels at a rate of at least 10 m/min during vacuum film deposition.
